(19) United States
(12) Patent Application Publication
(10) Pub. No.: US 2005/0111180 A1
(43) Pub. Date: May 26, 2005

(54) Burglarproff structure for extractable hard drive box

(75) Inventor: Yew-Min Song, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/874,276

(22) Filed: Jun. 24, 2004

(30) Foreign Application Priority Data
Nov. 26, 2003 (TW) 092220895

(51) Int. Cl. G06F 1/16

(52) U.S. Cl. 361/685

(57) ABSTRACT

A burglarproof structure for extractable hard drive box comprises a computer chassis having a front opening and an internal mounting member, and an extractable hard drive box including a mounting member, capable of being inserted into the computer chassis. It further comprises a mounting bracket having two through holes at two ends thereof and two locking members each for locking one end of the bracket onto one of the mounting members through one of the through holes, at least one of the locking members being removable. Hidden in the computer chassis, the burglarproof structure is therefore safer and hard to break.

### BACKGROUND OF THE INVENTION

1. Field of the Invention

The present invention relates to burglarproof structures for extractable hard drive box, more particularly to a burglarproof structure for extractable hard drive box mounted within a computer chassis.

2. Description of Related Art

The invention of removable or extractable hard drive boxes provides a convenient means of substituting and carrying data for computer users. However, due to its lack of reliable locking mechanisms, a removable hard drive is easy to be stolen away. Especially for a corporation, the loss of business data due to burglary of hard drives may cause serious damage to the competitiveness of the corporation.

Referring to FIG. 1, a conventional burglarproof structure for extractable hard drive box is a keylock 11 deposited on an external face of an extractable hard drive box 13 or a door mounted on a computer chassis 12 outside a hard drive bay, both for restricting withdrawing the hard drive box 13 from the computer chassis 12. Since the keylock 11 and the door are exposed outside the computer chassis 12, they are easy to break. Furthermore, for reducing the production cost, the keylocks for conventional extractable hard drive boxes provided by manufacturers are usually of simple structures or are even with identical keys, which cannot effectively protect the data contained in hard drives.

Therefore, it is desirable to provide an improved speech recognition method to mitigate and/or obviate the aforementioned problems.

### SUMMARY OF THE INVENTION

Accordingly, the primary objective of the present invention is to provide a burglarproof structure for extractable hard drive box which is safer and difficult to break.

To achieve the aforecited objective, the present invention provides a burglarproof structure for extractable hard drive box comprising a computer chassis having a front opening and an internal mounting member, and an extractable hard drive box including a mounting member, capable of being inserted into the computer chassis. It further comprises a bracket having two through holes at two ends thereof and two locking members each for locking one end of the bracket onto one of the mounting members through one of the through holes, at least one of the locking members being removable. Hidden in the computer chassis, the burglarproof structure is therefore safer and hard to break

Further, at least one of the aforesaid locking members is a screw, a clip or a clamp. At least one of aforesaid mounting members corresponding to the screw is a female screw mount, a clip coupler or a clamp coupler, for the locking member.

Further, the computer chassis may include a removable cover. By taking off the cover, those two locking members can be detached from the mounting bracket.

The various objects and advantages of the present invention will be more readily understood from the following detailed description of preferred embodiments, when read in conjunction with the appended drawings.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional locking structure for an extractable hard drive box.

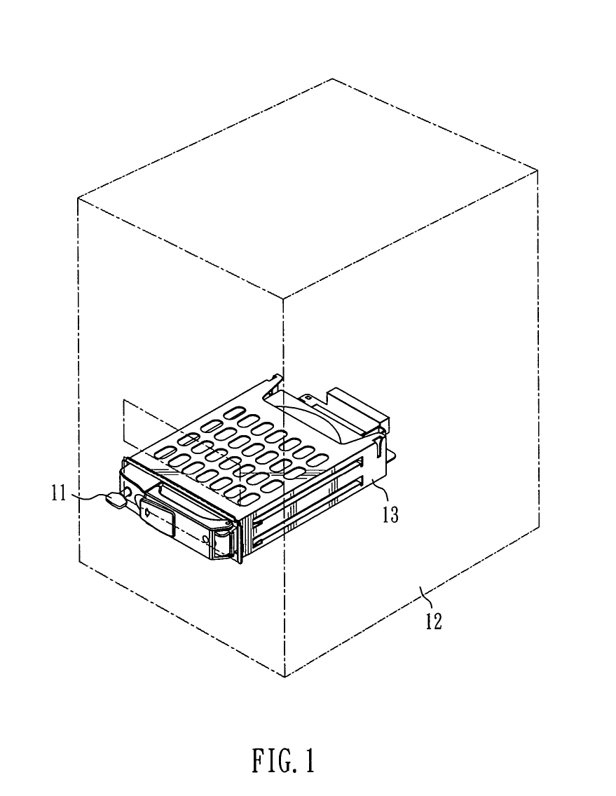

FIG. 2 is a perspective view of a preferred embodiment according to the present invention as a burglarproof structure for extractable hard drive box.

FIG. 3 is a perspective view of an enlarged local portion of the preferred embodiment in FIG. 2.

### DETAILED DESCRIPTION OF THE PREFERRED EMBODIMENT

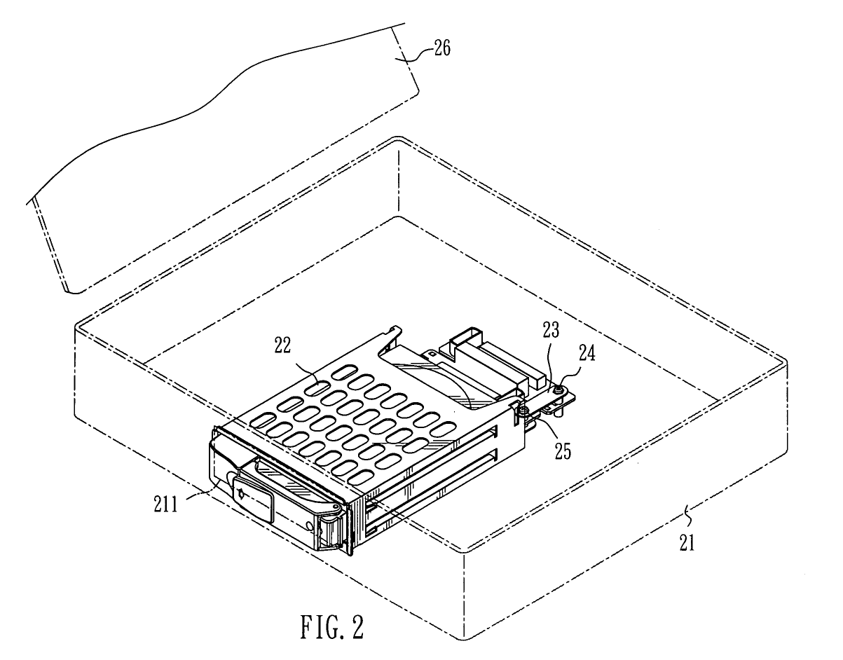

Referring to FIG. 2, a preferred embodiment according to the present invention as a burglarproof structure for extractable hard drive box comprises a computer chassis 21, an extractable hard drive box 22, a mounting bracket 23 and a pair of screws 24, 25. The computer chassis 21 is provided with an opening 211 for inserting or withdrawing the extractable hard drive box 22 through the front wall of the computer chassis 21. The computer chassis 21 further includes a removable cover 26; by opening the removable cover 26 the interior portion of the computer chassis 21 is exposed, and the extractable hard drive box 22 can be locked or dismounted.

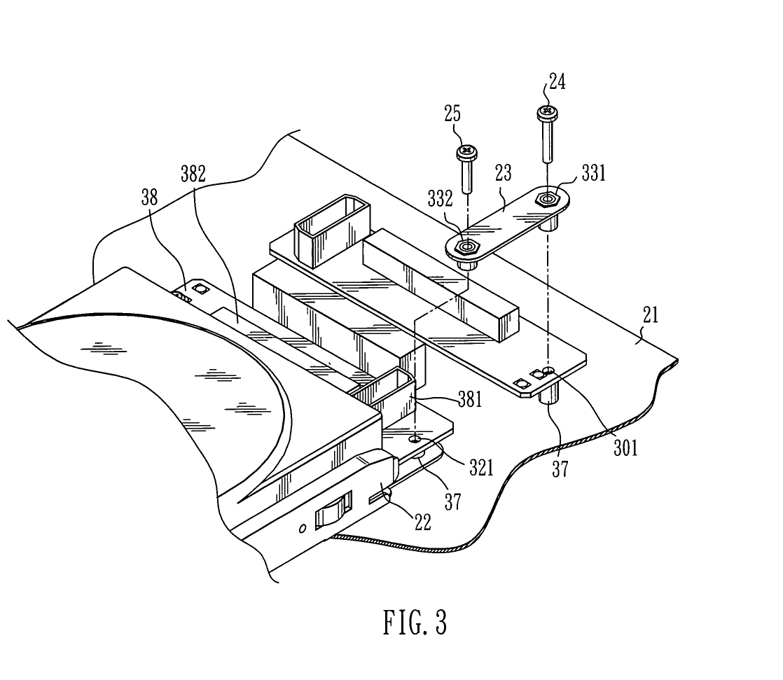

Referring to FIG. 3, the interior portion of the computer chassis 21 is provided with a first mounting point 301, which is weld connected with a female screw mount 37 on the inner bottom surface of the computer chassis 21. A second mounting point 321 is formed on a circuit board 38 in the rear portion of the extractable hard drive box 22. A female screw mount 37 is weld attached underneath the circuit board 38. The circuit board 38 is further provided with a power socket 381 and a connecting end 382, being an SCSI or IDE converter, for electrically connected with the computer.

The mounting bracket 23 is provided with a first through hole 331, a second through hole 332 and a pair of screws 24, 25. To mount the extractable hard drive box 22 onto the computer chassis 21, the screw 24 is put through the first through hole 331 and then is secured at the first mounting point 301 of the computer chassis 21. Another screw 25 is put through the second through hole 332 and then is secured at the second mounting point 321 on the circuit board 38 behind the extractable hard drive box 22. The extractable hard drive box 22 is thereby locked in the computer. To extract the extractable hard drive box 22, the screws 24, 25 are unscrewed and taken away from the mounting bracket 23, such that the extractable hard drive box 22 can be withdrawn from the opening 211 on the extractable hard drive box 22. Since the mounting bracket 23 is hidden within the computer, a hard drive box thereby locked is better safeguarded from burglary.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

Although the present invention has been explained in relation to its preferred embodiment, it is to be understood that many other possible modifications and variations can be made without departing from the spirit and scope of the invention as hereinafter claimed.

1. a burglarproof structure for extractable hard drive box comprising:
a computer chassis having an opening on a front face thereof, said computer chassis being further provided with a first mounting member therein;
an extractable hard drive box including a second mounting member capable of being inserted into said opening of said computer chassis;
a mounting bracket provided with a first through hole and a second through hole;
a first locking member for locking a first end of said mounting bracket onto said first mounting member on said computer chassis through said first through hole; and
a second locking member for locking a second end of said mounting bracket onto said second mounting member on said extractable hard drive box through said second through hole;
wherein at least one of said locking members is removable.

2. The burglarproof structure for extractable hard drive box of claim 1, wherein at least one of said locking members is a screw and at least one of said mounting members corresponding to said screw is a female screw mount for securing said screw.

3. The burglarproof structure for extractable hard drive box of claim 1, wherein said computer chassis includes a removable cover.
